(19) United States
(12) Patent Application Publication
(10) Pub. No.: US 2006/0169554 A1
(43) Pub. Date: Aug. 3, 2006

(54) Vibration force switch

(76) Inventor: Thomas A. Baudendistel, Farmersville, OH (US)

Correspondence Address: Delphi Technologies, Inc., M/C 480-410-202, P.O. Box 5052, Troy, MI, 48007-5052, US

(21) Appl. No.: 11/047,390

(22) Filed: Jan. 31, 2005

(51) Int. Cl. F16D 65/40

(52) U.S. Cl. 188/266.1; 267/140.14; 267/140.15

(57) ABSTRACT

A method for detecting an onset of clamping force in a system including the steps of introducing a vibration into the system, monitoring the vibration, and identifying a relative change in the vibration.

This invention was created in the performance of a cooperative research and development agreement with the Department of the Air Force (Contract No. F33615-01-2-5804/CRADA 01-156-PR-01). Thus, the government of the United States may have certain rights to the invention.

### BACKGROUND

The present invention is directed to a force switch and, more particularly, to a vibration force switch for detecting the onset of a clamping force.

FIG. 1 illustrates a typical electric park brake (or electric caliper) assembly 10, such as the type described in U.S. Pat. No. 6,550,598, the entire contents of which are incorporated herein by reference. The brake assembly 10 includes a caliper housing 12 having a ball screw assembly (not shown) slidably received therein. The ball screw assembly is adapted to translate a rotational force supplied by a motor (not shown) into linear movement of a piston 14. The piston 14 may also be advanced by an increase of hydraulic fluid pressure within the caliper housing 12.

The piston 14 typically is aligned with a first brake pad 16 such that linear advancement of the piston 14 causes linear advancement of the first brake pad 16 towards a rotor 18 (i.e., a brake disk). A second, fixed brake pad 20 is typically provided on an opposite side of the rotor 18 such that the rotor is positioned between the two brake pads 16, 20.

As the first brake pad 16 is advanced towards the rotor 18 (i.e., in the direction of arrow A), the brake pad 16 engages the rotor 18 such that the rotor is clamped between the two brake pads 16, 20. The clamping of the rotor 18 prevents the rotor from rotating about its axis, thereby supplying a braking force to an associated vehicle wheel. At this point it should be apparent that the braking force applied to the rotor 18 increases as the brake pad 16 (and piston 14) continue to advance in the direction of arrow A.

The brake assembly 10 may be modeled as a spring according to Hooke's Law for Springs and therefore the following equation 1 applies:
F=kX (1)
where F is the braking force, k is the spring constant for the assembly 10 and X is the relative distance the assembly 10 has been displaced from equilibrium. Thus, the amount of braking force applied to the rotor 18 may be determined based on the distance the piston 14 and first brake pad 16 have traveled (i.e., X in equation 1) after the initial application of braking force (i.e., the point at which the first brake pad 16 initially engages or touches the rotor 18 to clamp the rotor 18 between the two brake pads 16, 20).

Accordingly, there is a need for an apparatus and method for detecting the onset of force in a system such as the brake assembly 10.

### SUMMARY

One aspect of the present invention is a method for detecting an onset of clamping force in a system. The method includes the steps of introducing a vibration into the system, monitoring the vibration, and identifying a relative change in the vibration.

Another aspect of the present invention is a braking unit. The braking unit includes a caliper housing, a brake pad adapted for movement relative to the caliper housing to engage a rotor and a vibration-generating device connected to the caliper housing and adapted to introduce a vibration into the caliper housing, wherein the caliper housing vibrates at a first amplitude when the brake pad is not in contact with the rotor and a second amplitude when the brake pad is in contact with the rotor.

A third aspect of the present invention is a clamping apparatus. The clamping apparatus includes at least one clamping member adapted to clamp an object and a vibration-generating device connected to the clamping member and adapted to introduce a vibration into the clamping member, wherein the clamping member vibrates at a first amplitude when the object has not been clamped and a second amplitude when the object has been clamped.

Other embodiments, objects and advantages of the present invention will be apparent from the following description, the accompanying drawings and the appended claims.

### BRIEF DESCRIPTION OF THE DRAWINGS

FIG. 1 is a front elevational view of a typical electric brake assembly;

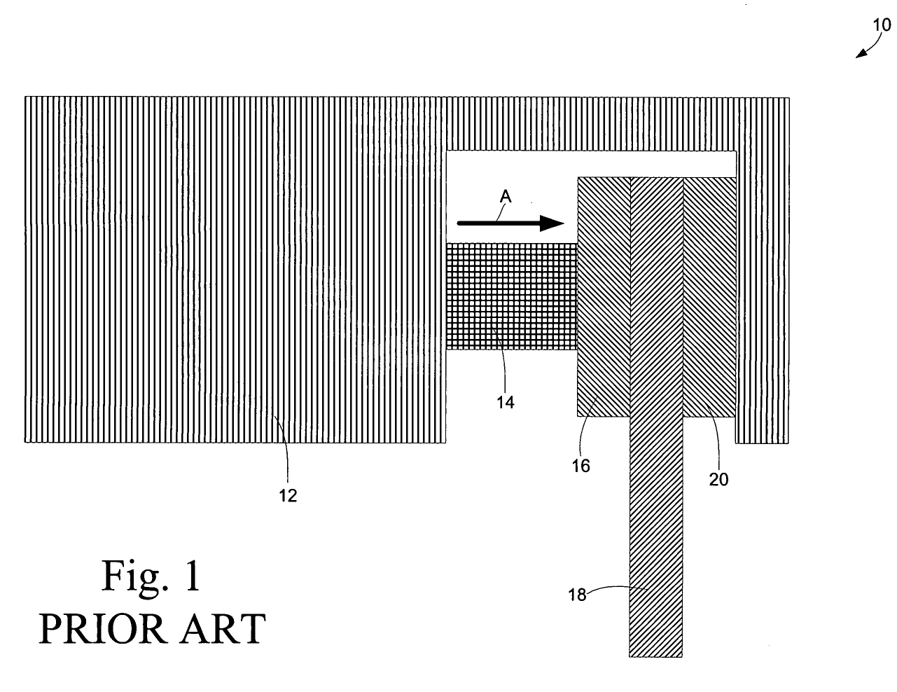

FIG. 2 is a front elevational view of a brake assembly in a non-engaged position according to one aspet of the present invention;

FIG. 3 is a front elevational view of the brake assembly of FIG. 1 in an engaged position; and

FIG. 4 is a graphical illustration of a vibration according to the present invention.

### DETAILED DESCRIPTION

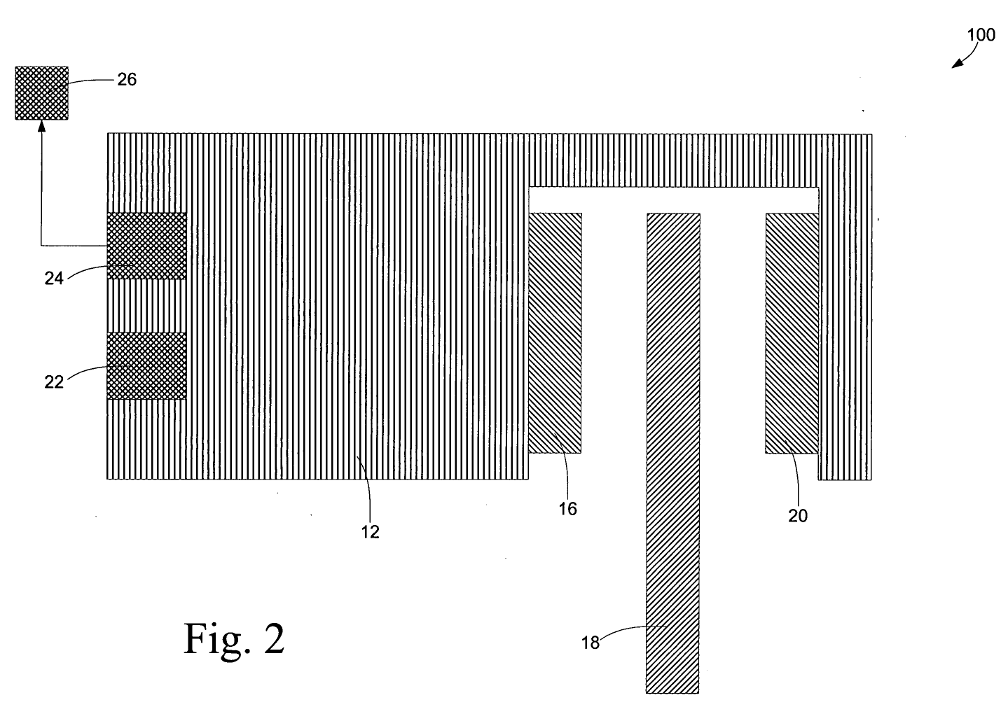

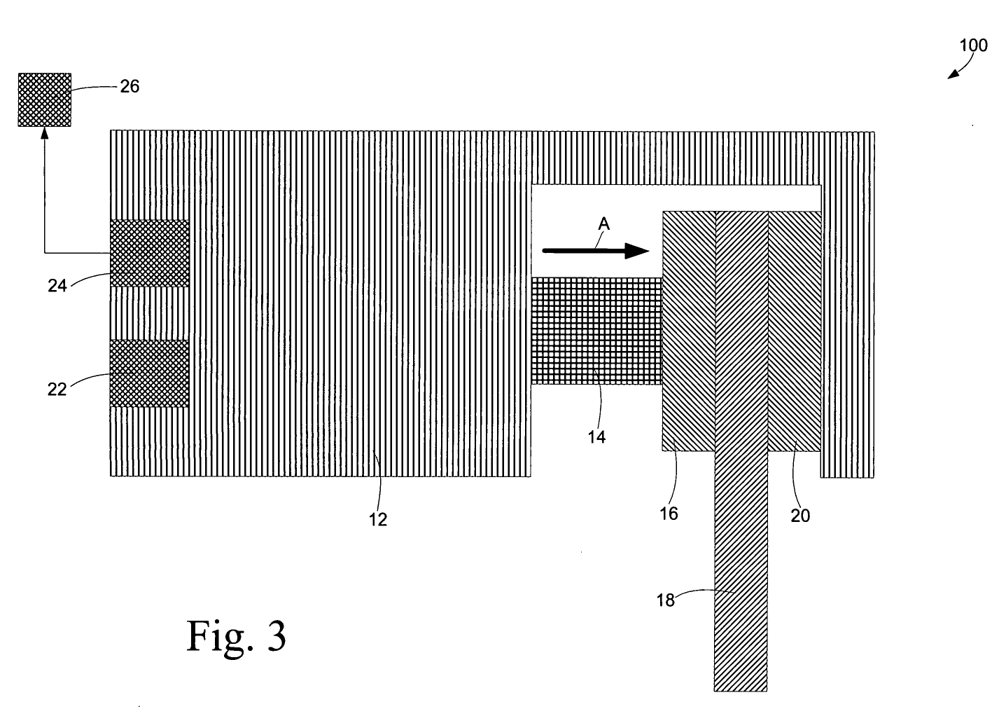

As shown in FIGS. 2 and 3, an electric brake assembly, generally designated 100, may include a caliper housing 12, a piston 14 and two brake pads 16, 20 for engaging a rotor 18. A vibration-generating device 22 is connected to the caliper housing 12. The word “connected” should not be limited to a physical connection, but rather should be understood to mean that the vibration-generating device 22 is positioned with sufficient proximity such that the vibration-generating device 22 is capable of introducing a vibration into the housing 12.

According to one aspect, the vibration-generating device 22 may be a piezo-electric device such as an ultrasound transceiver. Alternatively, an ultrasound transducer and a separate receiver may be used. The receiver may be positioned adjacent to or in the vicinity of the ultrasound transducer. According to a second aspect, the vibration-generating device 22 may be a motor having a natural vibrating frequency when operating. Those skilled in the art will appreciate that any device capable of generating a vibration within the caliper housing 12 may be used as the vibration-generating device 22 according to the present invention.

The vibration-generating device 22 may be positioned at various locations relative to, on or within the caliper housing 12. In one embodiment, the device 22 may be positioned to minimize exposure to heat generated by the assembly 100. In a second aspect, the device 22 may be positioned such that the excitation of the device 22 is parallel with the direction of arrow A (see FIG. 3). According to a third aspect, the device 22 is attached (e.g., via epoxy) to the inner lid (not shown) of the caliper housing 12.

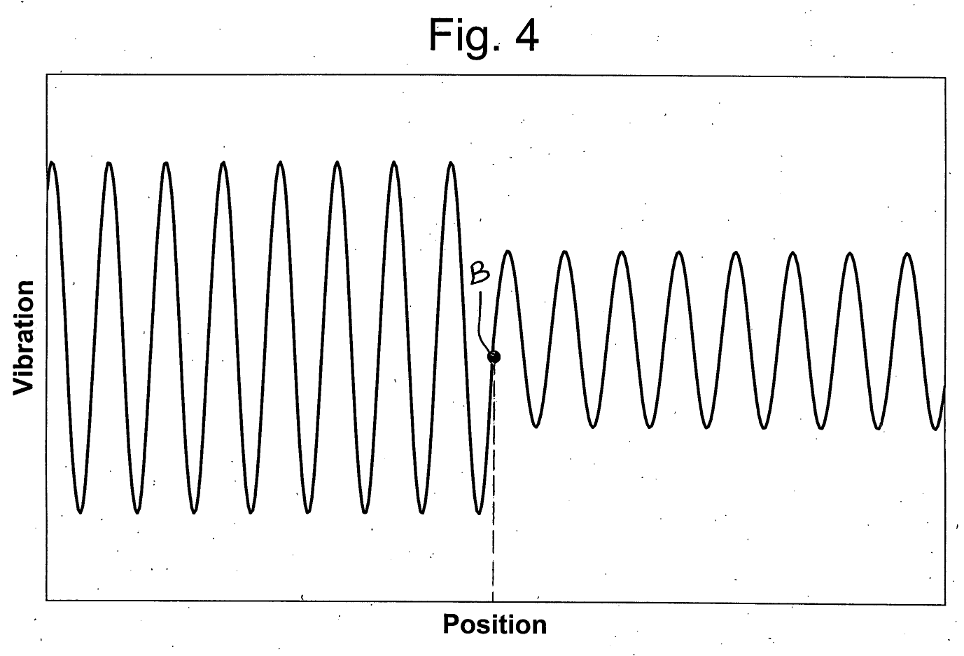

Referring to FIG. 4, the vibration-generating device 22 may be actuated to introduce a vibration into the system (i.e., brake assembly 100, FIG. 2) and is continuously monitored by a receiver 24, such as an ultrasound transceiver, during the advancement of the piston 14. The vibration may be continuous throughout the advancement of piston 14 and brake pad 16. According to one aspect, the receiver may include a band pass filter to eliminate noise and anomalous disruptions, thereby providing a more consistent vibration curve (see FIG. 4). However, at the point that the pads 16, 20 first contact the rotor 18 (i.e., the onset of force), designated point B in FIG. 4, the addition of the mass of the rotor 18 to the system dampens the vibration (i.e., there is a characteristic change in the vibration). The damping may be detected as a relative decrease in the amplitude of vibration (see FIG. 4) or as a relative change in the natural frequency of the overall system. The point B at which the relative change in vibration occurs corresponds to the relative position of the piston 14 when the pads 16, 20 first contact the rotor 18.

An braking control unit 26 may be provided to receive vibration signals from the receiver 24 and monitor the vibration of the system. The braking control unit 26 may determine the point B that corresponds to the pads 16, 20 contacting rotor 18. Furthermore, the braking control unit 26 may generate control signals for controlling the brake assembly 100 based on the vibration signals. Once point B has been determined, the braking control unit 26 may determine the amount of braking force applied to the rotor 18 based on the position of the piston 14 relative to point B. Alternatively, the braking control unit 26 may include a band pass filter, rather than the receiver 24.

Although the invention is shown and described with respect to certain embodiments, equivalents and modifications will occur to those skilled in the art upon reading and understanding the specification. The present invention includes all such equivalents and modifications and is limited only by the scope of the claims.

What is claimed is:

1. A method for detecting contact between a first body and a second body comprising the steps of:
introducing a vibration into said first body;
bringing said first body into contact with said second body; and
determining a point of contact between said first body and said second body by detecting a characteristic change in said vibration in said first body.

2. The method of claim 1 wherein said characteristic change is a change in an amplitude of said vibration.

3. The method of claim 1 wherein said first body is a brake pad and said second body is a rotor.

4. The method of claim 3 wherein said point of contact corresponds to a point at which said brake pad first contacts said rotor.

5. The method of claim 1 further comprising the step of communicating said point of contact to an electronic control unit.

6. The method of claim 5 further comprising the step of generating a control signal based on said point of contact.

7. The method of claim 1 further comprising the step of band passing said vibration to eliminate noise.

8. The method of claim 1 wherein said vibration is generated by a piezo-electric device.

9. The method of claim 8 wherein said piezo-electric device includes an ultrasound transducer.

10. The method of claim 1 wherein said vibration is generated and monitored by an ultrasound transceiver.

11. The method of claim 1 wherein said characteristic change is a change in a frequency of said vibration.

12. A braking unit comprising:
a caliper housing;
a brake pad adapted for movement relative to said caliper housing to engage a rotor; and
a vibration-generating device connected to said caliper housing and adapted to introduce a vibration into said caliper housing,
wherein said caliper housing vibrates at a first amplitude when said brake pad is not in contact with said rotor and a second amplitude when said brake pad is in contact with said rotor.

13. The braking unit of claim 12 further comprising a piston for advancing said brake pad towards said rotor.

14. The braking unit of claim 12 wherein said vibration-generating device is a piezo-electric device.

15. The braking unit of claim 14 wherein said piezo-electric device includes an ultrasound transducer.

16. The braking unit of claim 12 wherein said vibration-generating device includes an ultrasound transceiver.

17. The braking unit of claim 12 further comprising a receiver for monitoring said vibration.

18. The braking unit of claim 17 wherein said receiver is adapted to generate a signal corresponding to said vibration and communicating said signal to an electronic control unit.

19. The braking unit of claim 18 further comprising a band pass filter adapted to receive said signal and filter noise from said signal.

20. The braking unit of claim 12 wherein said vibration-generating device vibrates at a constant amplitude and frequency.

21. A clamping apparatus comprising:
at least one clamping member adapted to clamp an object; and
a vibration-generating device connected to said clamping member and adapted to introduce a vibration into said clamping member,
wherein said clamping member vibrates at a first amplitude when said object has not been clamped and a second amplitude when said object has been clamped.

22. The clamping apparatus of claim 21 further comprising a receiver adapted to monitor the vibration in said clamping member.

23. The clamping apparatus of claim 22 wherein said receiver and said vibration-generating device are a single unit.
